(19) United States
(12) Patent Application Publication
(10) Pub. No.: US 2025/0053806 A1
(43) Pub. Date: Feb. 13, 2025

(54) SPARSIFICATION TARGET LAYER DETERMINATION APPARATUS, SPARSIFICATION TARGET LAYER DETERMINATION METHOD, AND PROGRAM

(71) Applicant: NEC Corporation, Minato-ku, Tokyo (JP)

(72) Inventor: Seiya Shibata, Tokyo (JP)

(73) Assignee: NEC Corporation, Minato-ku, Tokyo (JP)

(21) Appl. No.: 18/720,771

(22) PCT Filed: Dec. 22, 2021
(86) PCT No.: PCT/JP2021/047700

§ 371 Date: Jun. 17, 2024

(51) Int. Cl. G06N 3/08; G06N 3/045

(52) U.S. Cl. CPC G06N 3/08; G06N 3/045

(57) ABSTRACT

A sparsification target layer determination apparatus includes: an each-layer sparsity speed contribution investigation part which receives a neural network model which includes a plurality of layers each of which has weights and one or more sparse weight neural network models which have sparse weights obtained by applying sparsification to the weights, layer by layer, and investigates, layer by layer, an execution time of the neural network model and one or more execution times of the one or more sparse weight neural network models; and a sparsification target layer determination part which determines whether or not to apply sparsification to the weights of the neural network model, layer by layer, based on a result of the investigation.

### TECHNICAL FIELD

The present invention relates to a sparsification target layer determination apparatus, a sparsification target layer determination method, and a program.

### BACKGROUND ART

As to a neural network (NN) model, weights of each layer are generally dense (Dense), that is, weights of each layer are often made up of a lot of non-zero values. Furthermore, non-zero values often account for approximately 100% of values in weights. In contrast, an NN model having sparse (Sparse) weights including a lot of zero-values can be executed with high speed. In a case where weights are sparsified, a precision thereof is slightly degraded, but it has been known that a ratio of zero values in weights can be increased by devising a method of training (learning). A method of speeding-up by utilizing sparsity of weights, that is, “sparsity=a lot of zero values” has been proposed.

Patent Literature (PTL) 1 relates to a method for determining a processing unit (tile size) in executing a neural network model which has already been sparsified.

PTL 2 relates to a method for providing a sparse network model while minimizing trade-off in model accuracy.

PTL 3 relates to a high-speed sparse optimization device.

PTL 4 relates to a method for executing a sparsified neural network model with high speed.

### CITATION LIST

### Patent Literature

PTL 1: Japanese Patent Kokai Publication No: 2021-093131

PTL 2: Japanese Patent Kokai Publication No: 2021-006980

PTL 3: Japanese Patent Kokai Publication No: 2020-102073

PTL 4: Japanese Patent Kohyo Publication No: 2019-522850

### SUMMARY

### Technical Problem

The following analysis has been given by the present invention.

In the meanwhile, there may be that it is not possible to fully (100%) utilize sparsity of weights for speeding-up an execution speed. For example, although sparsity of weights is 90%, that is, a ratio of non-zero values in weights is 10%, an execution speed is not necessarily speeded-up by 10 times higher than that in a case where sparsification is not carried out. This is caused by constraints imposed by a parameter, such as a batch size (N), a number of channels (C), a height (H), a width (W), and a relationship as to a hardware operation and parallelism of memory access, whereby a case where sparsity can be utilized is limited. Furthermore, a degree of sparsity (a ratio of zero-values) obtained in each layer may result in a different outcome in such way that a layer has 90% and another layer has 70%. Furthermore, there is a case where the closer a degree for sparsity becomes to be 100%, the higher an effect of speeding-up of execution speed becomes. In contrast, there may be a case where the execution speed is not speeded-up at all when the degree of sparsity becomes lower than or equal to a predetermined value.

It is an object of the present invention to provide a sparsification target layer determination apparatus, a sparsification target layer determination method, and a program which contribute to determine whether or not to apply sparsification to weights of a neural network (NN) model in an implementation target (real machine).

### Solution To Problem

According to a first aspect of the present invention, there is provided a sparsification target layer determination apparatus, comprising:

an each-layer sparsity speed contribution investigation part which receives a neural network model which includes a plurality of layers each of which has weights and one or more sparse weight neural network models which have sparse weights obtained by applying sparsification to the weights, layer by layer, and investigates, layer by layer, an execution time of the neural network model and one or more execution times of the one or more sparse weight neural network models; and
a sparsification target layer determination part which determines whether or not to apply sparsification to the weights of the neural network model, layer by layer, based on a result of the investigation.

According to a second aspect of the present invention, there is provided a sparsification target layer determination method, comprising:

a step of receiving a neural network model which includes a plurality of layers each of which has weights and one or more sparse weight neural network models which have sparse weights obtained by applying sparsification to the weights, layer by layer, and investigating, layer by layer, an execution time of the neural network model and one or more execution times of the one or more sparse weight neural network models; and
a step of determining whether or not to apply sparsification to the weights of the neural network model, layer by layer, based on a result of the investigation.

According to a third aspect of the present invention, there is provided a program which causes a computer to perform processings of:

receiving a neural network model which includes a plurality of layers each of which has weights and one or more sparse weight neural network models which have sparse weights obtained by applying sparsification to the weights layer by layer and investigating, layer by layer, an execution time of the neural network model and one or more execution times of the one or more sparse weight neural network models; and
determining whether or not to apply sparsification to the weights of the neural network model, layer by layer, based on a result of the investigation. Note, this program can be recorded in a computer-readable storage medium. The storage medium can be non-transitory one, such as a semiconductor memory, a hard disk, a magnetic recording medium, an optical recording medium, and so on. The present invention can be realized by a computer program product.

### Advantageous Effects of Invention

According to the present invention, it is possible to provide a sparsification target layer determination apparatus, a sparsification target layer determination method, and a program which contribute to determine whether or not to apply sparsification to weights of a neural network (NN) model in an implementation target (real machine).

### BRIEF DESCRIPTION OF DRAWINGS

FIG. 1 is a diagram illustrating an example of a configuration of a sparsification target layer determination apparatus according to an example embodiment of the present invention.

FIG. 2 is a diagram illustrating an example of a configuration of a sparsification target layer determination apparatus according to a first example embodiment of the present invention.

FIG. 3 is a diagram illustrating an example of a case where uniformly random sparse weights are generated according to a first example embodiment of the present invention.

FIG. 4 is a diagram illustrating an example of a case where random sparse weights according to a predetermined pattern are generated according to the first example embodiment of the present invention.

FIG. 5 is a diagram illustrating an example of an outline of a sparsification applicable layer list outputted by a sparsification target layer determination apparatus according to the first example embodiment of the present invention.

FIG. 6 is a diagram illustrating an example of an execution time to a degree of sparsity and an increase ratio of execution time compared to a Dense case execution time of a sparsification target layer determination apparatus according to the first example embodiment of the present invention.

FIG. 7 is a diagram illustrating another example of an outline of a sparsification applicable layer list outputted by a sparsification target layer determination apparatus according to the first example embodiment of the present invention.

FIG. 8 is a diagram illustrating an example of a configuration of a sparsification target layer determination apparatus according to a second example embodiment of the present invention.

FIG. 9 is a diagram illustrating an example of a configuration of a dense weight/sparse weight execution speed measurement result database according to the second example embodiment of the present invention.

FIG. 10 is a flow diagram illustrating an example of an outline for an algorithm of an operation by an each-layer sparsity speed contribution investigation part of a sparsification target layer determination apparatus according to the second example embodiment of the present invention.

FIG. 11 is a flow diagram illustrating another example of an outline for an algorithm of an operation by each-layer sparsification speed contribution investigation part of a sparsification target layer determination apparatus according to a modified example of the second example embodiment of the present invention.

FIG. 12 is a diagram illustrating a configuration of a computer which can make up a sparsification target layer determination apparatus of the present invention.

### EXAMPLE EMBODIMENTS

First, an outline of an example embodiment of the present invention will be described with reference to drawings. Note, in the following outline, reference signs of the drawings are denoted to each element as an example for the sake of convenience to facilitate understanding, however, the present invention is not limited thereto. An individual connection line between blocks in the drawings, etc., referred to in the following description includes both one-way and two-way directions. A one-way arrow schematically illustrates a principal signal (data) flow and does not exclude bidirectionality.

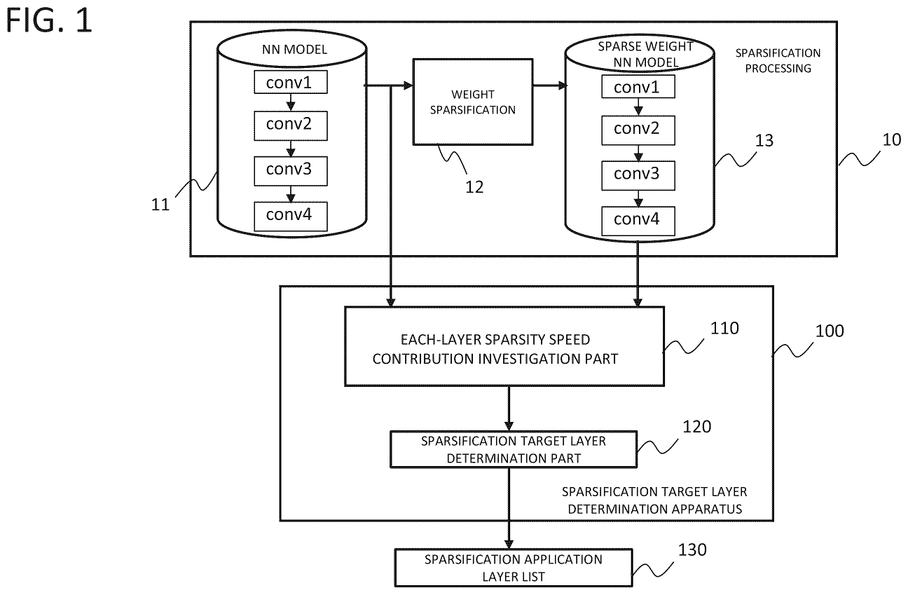

FIG. 1 is a diagram illustrating an example of a configuration of a sparsification target layer determination apparatus 100 according to an example embodiment of the present invention. A sparsification processing 10 as shown in FIG. 1 represents a processing of generating in advance an input to a sparsification target layer determination apparatus 100 according to the example embodiment of the present invention. The sparsification processing 10 executes a processing to generate one or more sparse weight neural network models 13 having sparse weights by applying, for layer by layer, weight sparsification 12 to weights (dense weights) of each layer of a neural network model 11. The neural network model 11 and the one or more sparse weight neural network models 13 generated in advance by the sparsification processing 10 as described above are inputted to the sparsification target layer determination apparatus 100 according to the example embodiment of the present invention. Note, sparsity of weights represents that there are lot of zero values in weights. It is assumed that, by weight sparsification, sparse weight neural network models 13 in which a lot of zero value are included in weights are generated. Note, a calculation of a sparse weight neural network model is speeded-up when an implementation target (real machine) executing a model including zero values in weights has a mechanism to skip the zero values. Therefore, a speed to execute a model depends on the real machine.

With reference to FIG. 1, as an example, the neural network model 11 can be configured by four (4) layer neural network model including a conv1 layer, a conv2 layer, a conv3 layer, and a conv4 layer. For example, in a case of a convolutional neural network (CNN) and so on, a conv1 layer, a conv2 layer, a conv3 layer, and a conv4 layer may be, for example, convolutional layers. Each sparse weight neural network model 13 includes a conv1 layer, a conv2 layer, a conv3 layer, and a conv4 layer which are the same as those of the neural network model 11.

With reference to FIG. 1, the sparsification target layer determination apparatus 100 according to the example embodiment of the present invention includes an each-layer sparsity speed contribution investigation part 110 and a sparsification target layer determination part 120. The each-layer sparsity speed contribution investigation part 110 receives a neural network model 11 which includes a plurality of layers each of which has weights and one or more sparse weight neural network models 13 which have sparse weights obtained by applying sparsification 12 to the weights, layer by layer. Each layer may be, for example, a conv1 layer, a conv2 layer, a conv3 layer, and a conv4 layer,

As described above, because a calculation of a sparse weight neural network model is speeded-up by a mechanism and so on to skip the zero values of weights provided to the real machine, at least the each-layer sparsity speed contribution investigation part 110 of the sparsification target layer determination apparatus 100 according to the example embodiment of the present invention is configured on a real machine to be executed in order to evaluate whether or not the calculation is speeded-up. Note, whole of the sparsification target layer determination apparatus 100 may be configured on an implementation target (real machine) to be executed.

Note, as to each layer of a conv1 layer, a conv2 layer, a conv3 layer, and a conv4 layer of the neural network model 11, calculations are performed for all of the weights (dense weights). In contrast, because each layer of a conv1 layer, a conv2 layer, a conv3 layer, and a conv4 layer of the one or more sparse weight neural network models 13 are neural network models including sparsified weights of zero values by the weight sparsification 12, in a case where a real time machine which executes calculation of this sparse weight neural network models has a mechanism and so on to skip the zero values, the sparse weight neural network models are calculated using the mechanism and so on to skip the zero values

The each-layer sparsity speed contribution investigation part 110 further investigates, layer by layer, an execution time of the neural network model 11 and one or more execution times of the one or more sparse weight neural network models 13.

A sparsification target layer determination part 120 determines whether or not to apply sparsification to the weights of the neural network model 11, layer by layer, based on a result of the investigation of the each-layer sparsity speed contribution investigation part 110. The sparsification target layer determination part 120 furthermore outputs a sparsification application layer list 130 which represents whether or not to apply sparsification determined as described above.

According to a sparsification target layer determination apparatus 100 according to the example embodiment of the present invention, it is possible to provide a sparsification target layer determination apparatus which contributes to determine whether or not to apply sparsification to weights of a neural network (NN) model in an implementation target (real machine). In addition, it is possible to output a sparsification application layer list 130 which represents whether or not to apply sparsification to weights that has been determined. A sparsification application layer list 130 may represent whether or not to apply sparsification to weights, layer by layer, for example, of a conv1 layer, a conv2 layer, a conv3 layer, and a conv4 layer.

### FIRST EXAMPLE EMBODIMENT

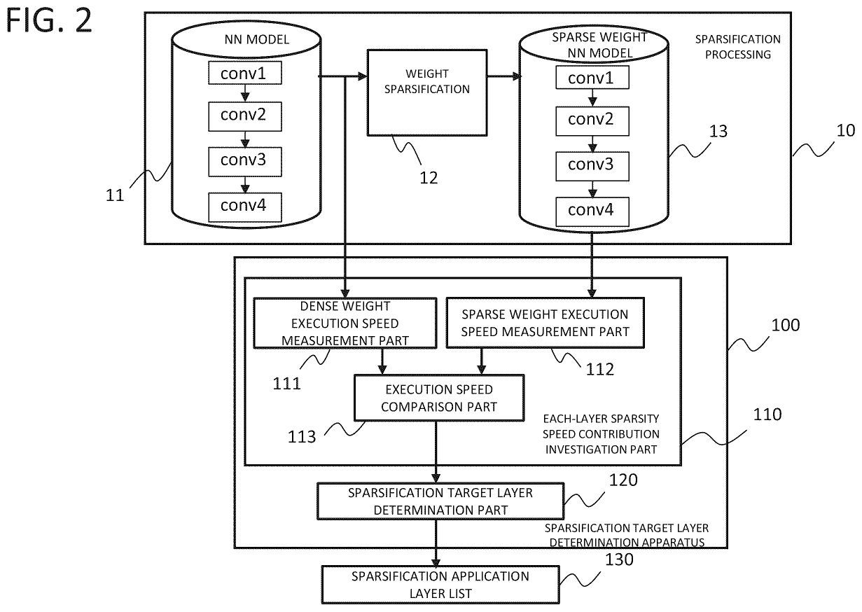

Next, a sparsification target layer determination apparatus 100 according to a first example embodiment of the present invention will be described with reference to drawings. FIG. 2 is a diagram illustrating an example of a configuration of a sparsification target layer determination apparatus 100 according to the first example embodiment of the present invention. In FIG. 2, components denoted by the same reference numerals as those in FIG. 1 indicate the same components, and description thereof will be omitted.

With reference to FIG. 2, a sparsification target layer determination apparatus 100 according to the first example embodiment of the present invention includes an each-layer sparsity speed contribution investigation part 110 and a sparsification target layer determination part 120. The each-layer sparsity speed contribution investigation part 110 includes a dense weight execution speed measurement part 111, a sparse weight execution speed measurement part 112, and an execution speed comparison part 113.

With reference to FIG. 2, a sparsification processing 10 includes a processing for executing weight sparsification 12. The weight sparsification 12 may use a method for performing sparsification by searching weights which can be set to zero values while degradation of accuracy of calculation performed, layer by layer, is kept low, for weights of each of layers such as, for example, a conv1 layer, a conv2 layer, a conv3 layer, and a conv4 layer of a neural network (NN) model to which normal training (learning) has been performed.

Furthermore, in a sparsification processing 10, to weights of each of layers of an NN model to which normal training (learning) has been performed or without determining weights of each of layers, by applying weight sparsification 12 to predetermined locations of weights of each of layers to generate one or more sparse weight neural network models 13 which have sparse weighs in which weights are set to zero values.

Furthermore, in a sparsification processing 10, it is possible to generate one or more sparse weight neural network models 13 which have sparse weighs obtained by applying sparsification using a different degree of sparsification in such way, for example, that X % of weights are randomly sparsified to zero values, layer by layer.

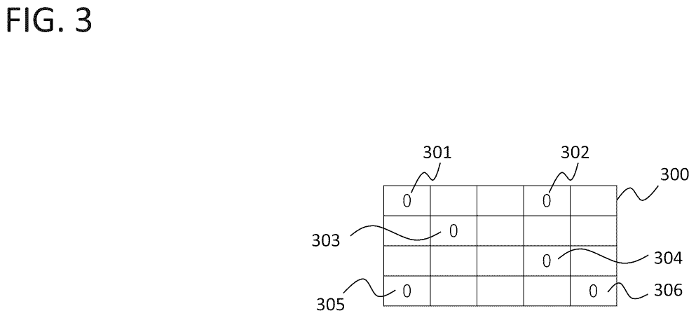

FIG. 3 is a diagram illustrating an example of a processing of weight sparsification 12 which illustrating a case where uniformly random sparse weights are generated, as an example. FIG. 3 illustrate an example of a case where sparsification is performed to weights in a weight showing matrix 300 by setting weights to zero values at random locations 301 to 306 with a ratio of X %.

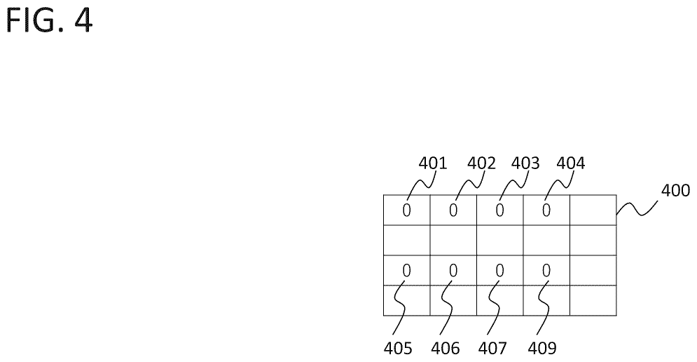

FIG. 4 is a diagram illustrating another example of a processing of weight sparsification 12 which illustrating a case where X % of random sparse weights according to a predetermined pattern are generated, as an example. FIG. 4 illustrate an example of a case where sparsification is performed to weights in a weight showing matrix 400 by setting weights to zero values at a predetermined patterns 401 to 404 and a predetermined patterns 405 to 408 with a ratio of X %. Note, examples illustrated in FIGS. 3 and 4 are just examples and other types of sparsification than a uniformly random type or a random type according to a predetermined pattern are not excluded. Furthermore, a uniformly random pattern and a predetermined pattern are not limited to be arranged as described above.

The sparsification target layer determination apparatus 100 according to the example embodiment of the present invention receives a neural network model 11 and one or more sparse weight neural network models 13 generated in advance by a sparsification processing 10. Furthermore, a calculation of a sparse weight neural network model is speeded-up by a mechanism and so on, which a real machine has, to skip the zero values. Therefore, the dense weight execution speed measurement part 111 and the sparse weight execution speed measurement part 112 of at least the each-layer sparsity speed contribution investigation part t 110 according to the example embodiment of the present invention are configured and executed on an implementation target (real machine) in order to evaluate whether or not a calculation is speeded-up. Note, the each-layer sparsity speed contribution investigation part 110 or whole of the sparsification target layer determination apparatus 100 may be configured on an implementation target (real machine) to be executed.

With reference to FIG. 2, an operation of the sparsification target layer determination apparatus 100 of the example of embodiment of the present invention will be described below.

With reference to FIG. 2, the dense weight execution speed measurement part 111 of the each-layer sparsity speed contribution investigation part 110 performs calculations for all of weights (dense weights) of each layer of a conv1 layer, a conv2 layer, a conv3 layer, and a conv4 layer of a neural network model 11 to measure execution times of calculations, layer by layer.

On the other hand, because each layer of a conv1 layer, a conv2 layer, a conv3 layer, and a conv4 layer of the one or more sparse weight neural network models 13 is a neural network model having a configuration sparsified by setting weights to zero values using weight sparsification 12, the sparse weight execution speed measurement part 112 executes calculations using a mechanism and so on to skip the zero values when a real machine executing calculation of this sparse weight neural network model has the mechanism and so on to skip the zero values. That is, because a speed to execute the sparse weight neural network model depends on the real machine, the sparse weight execution speed measurement part 112 executes calculations of the sparse weight neural network model using the mechanism and so on to skip zero values on the real time machine, and measures respective execution times of calculations of the one or more sparse weight neural network models 13, layer by layer.

The execution speed comparison part 113 compares, layer by layer, a measured values of an execution time of a calculation of the dense weight execution speed measurement part 111 with a measured values of an execution time of a calculation of the sparse weight execution speed measurement part 112, and investigates increase ratios of execution speeds of calculations of the sparse weight execution speed measurement part 112, layer by layer, based on a result of comparison.

The sparsification target layer determination part 120 determines that sparsification is applied to weights of a layer of a neural network model 11 whose reduction value of an execution time is more than or equal to a predetermined value.

An examples of determination methods to determine whether or not to apply sparsification is described below but the present invention is not limited thereto.

### EXAMPLE OF FIRST DETERMINATION METHOD

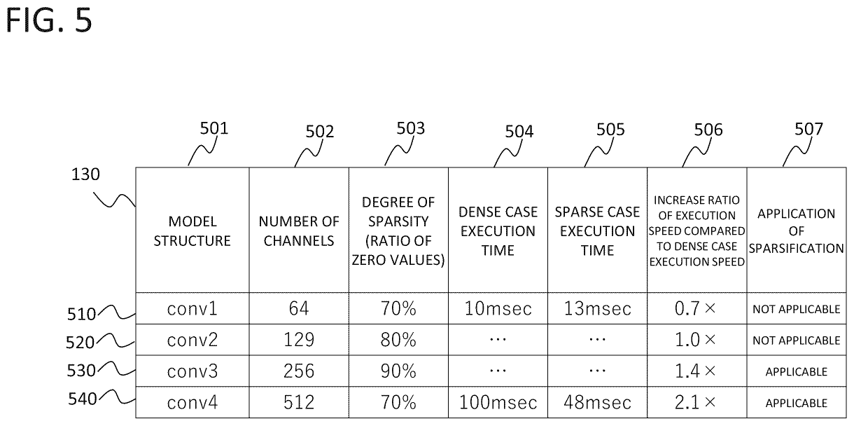

FIG. 5 is a diagram illustrating an example of an outline of a sparsification applicable layer list outputted by a sparsification target layer determination apparatus according to the first example embodiment of the present invention. FIG. 5 illustrates an example of a sparsification applicable layer list 130 which represents whether or not sparsification is to be applied according to a first determination Note, FIG. 5 illustrates an example of a sparsification method. applicable layer list 130 in a case where only one sparse weight neural network model 13 is received as an input. With reference to FIG. 5, a sparsification applicable layer list 130 includes each column of a model structure 501, a number of channels 502, a degree of sparsity (ratio of zero values) 503, a Dense case execution time 504, a Sparse case execution time 505, an increase ratio of execution speed compared to a Dense case execution speed 506, and an application of sparsification 507. Furthermore, rows 510 to 540 respectively correspond to a conv1 layer to a conv4 layer as shown in FIG. 1.

In FIG. 5, it is shown that an increase ratio of an execution speed compared to a Dense case execution speed 506 for a conv1 layer is 0.7 times (0.7 X), an increase ratio of an execution speed compared to a Dense case execution speed 506 for a conv2 layer is 1.0 times (1.0 X), an increase ratio of an execution speed compared to a Dense case execution speed 506 for a conv3 layer is 1.4 times (1.4 X), and an increase ratio of an execution speed compared to a Dense case execution speed 506 for a conv4 layer is 2.1 times (2.1 X). For example, as a method to determine whether or not to apply sparsification, in a case where it is determined to apply sparsification when an increase ratio of an execution speed compared to a Dense case execution speed 506 is greater than or equal to 1.4 times, it is determined that sparsification is applied to the conv3 layer and the conv4 layer of the neural network model 11 and sparsification is not applied to the conv1 layer and the conv2 layer of the neural network model 11 and applicable/not applicable is represented in the column of the application of sparsification 507.

### EXAMPLE OF SECOND DETERMINATION METHOD

Meanwhile, in a case where a plurarity of sparse weight neural network models 13 are inputted, the dense weight execution speed measurement part 111 of the each-layer sparsity speed contribution investigation part 110 measures an execution time of the neural network model 11, layer by layer. On the other hand, the sparse weight execution speed measurement part 112 measures, layer by layer, respective execution times of the plurarity of sparse weight neural network models 13. The execution speed comparison part 113 compares, layer by layer, an execution time of a neural network model 11 and respective execution times of the plurarity of sparse weight neural network models and investigates respective increase ratios of execution speeds, layer by layer, based on a result of comparison.

The sparsification target layer determination part 120 may determine that sparsification is applied to weights of a layer of a neural network model 11 corresponding to a layer for which any one of increase ratio of an execution speed among the plurarity of sparse weight neural network models is greater than or equal to a predetermined value.

### EXAMPLE OF THIRD DETERMINATION METHOD

Furthermore, in a case where a plurarity of sparse weight neural network models 13 are received as an input, it is possible to determine a layer to which sparsification is not applied as described below.

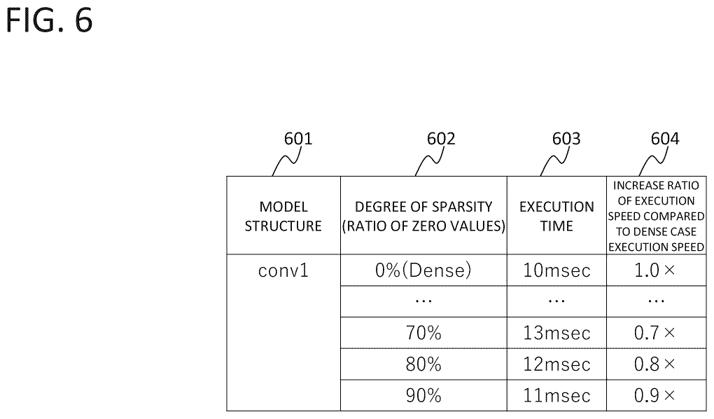

FIG. 6 is a diagram illustrating an example of an execution time to a degree of sparsity and an increase ratio of an execution time compared to a Dense case execution time for a conv1 layer of a neural network model 11. A degree of sparsity of 0% indicates a Dense case. That is, an execution time 603 of 10 msec (milliseconds) indicates an execution speed of a conv1 layer of a neural network model 11.

On the other hand, examples of degrees of sparsity of 70%, 80% and 90% indicate respective execution times 603 when a conv1 layer has been executed with respective degrees of sparsity by the plurality of sparse weight neural network models 13 including sparse weights to which sparsification with different degrees of sparsity are applied. In the example as shown in FIG. 6, in a case where a degree of sparsity is 70%, an execution time of a conv1 layer is 13 msec and an increase ratio of an execution speed compared to a Dense case execution speed is 0.7 times (0.7 X). In a case where a degree of sparsity is 80%, an execution time of a conv1 layer is 12 msec and an increase ratio of execution speed compared to a Dense case execution speed is 0.8 times (0.8 X). In a case where a degree of sparsity is 90%, an execution time of a conv1 layer is 11 msec and an increase ratio of execution speed compared to a Dense case execution speed is 0.9 times (0.9 X).

As shown in an example of FIG. 6, in a case where an execution speed cannot be speeded-up from a Dense case execution speed at any degree of sparsity, it may be determined that sparsification is not applied to the weights of the layer of the neural network model 11.

### EXAMPLE OF FOURTH DETERMINATION METHOD

In a case where a target execution time has been determined for a neural network model 11 as a whole, it is possible to employ a determination criterion for applying sparsification by which (at least) only a minimum number of layers which can achieve the target execution time becomes targets to be sparsified.

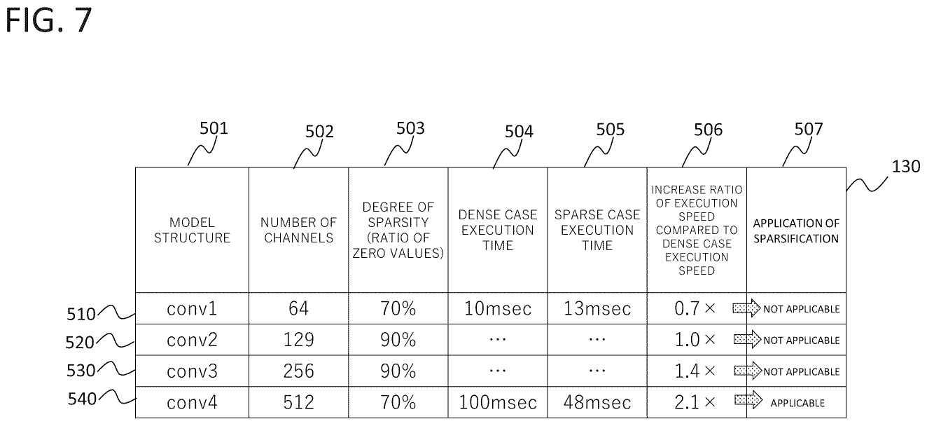

FIG. 7 is a diagram illustrating another example of an outline of a sparsification applicable layer list 130 outputted by a sparsification target layer determination apparatus 100 according to the first example embodiment of the present invention. FIG. 7 shows an example of a sparsification applicable layer list 130 which represents whether or not to apply sparsification according to the fourth determination method. In FIG. 7, components denoted by the same reference numerals as those in FIG. 5 indicate the same components, and description thereof will be omitted.

For example, it is assumed that speeding-up by a reduction of an execution time of 50 msec (milliseconds) is necessary to satisfy a target execution time, for a neural network model 11 as a whole. Note, FIG. 7 illustrates an example of a sparsification applicable layer list 130 in a case where only one sparse weight neural network model 13 is received as input. With reference to FIG. 7, a reduction of a Sparse case execution time from a Dense case execution time for a conv4 layer is 52 msec (milliseconds) whereby the reduction of an execution time exceeds 50 msec (milliseconds) by sparsifying only the conv4 layer. Therefore, by applying sparsification to only the conv4 layer, a reduction of an execution time more than or equal to 50 msec can be achieved for the neural network model 11 as a whole. In such case, it is indicated that sparsification is applied at a column of the application of sparsification 507 for the conv4 layer of the neural network model 11 and it is indicated that sparsification is not applied at a column of the application of sparsification 507 for the conv1 layer, the conv2 layer, and the conv3 layer of the neural network model 11.

As described above, it is possible to reduce a possibility of degradation of a calculation accuracy by not applying sparsification more than necessary even if sparsification of other layers is effective for speeding-up of an execution time of a neural network model 11.

### SECOND EXAMPLE EMBODIMENT

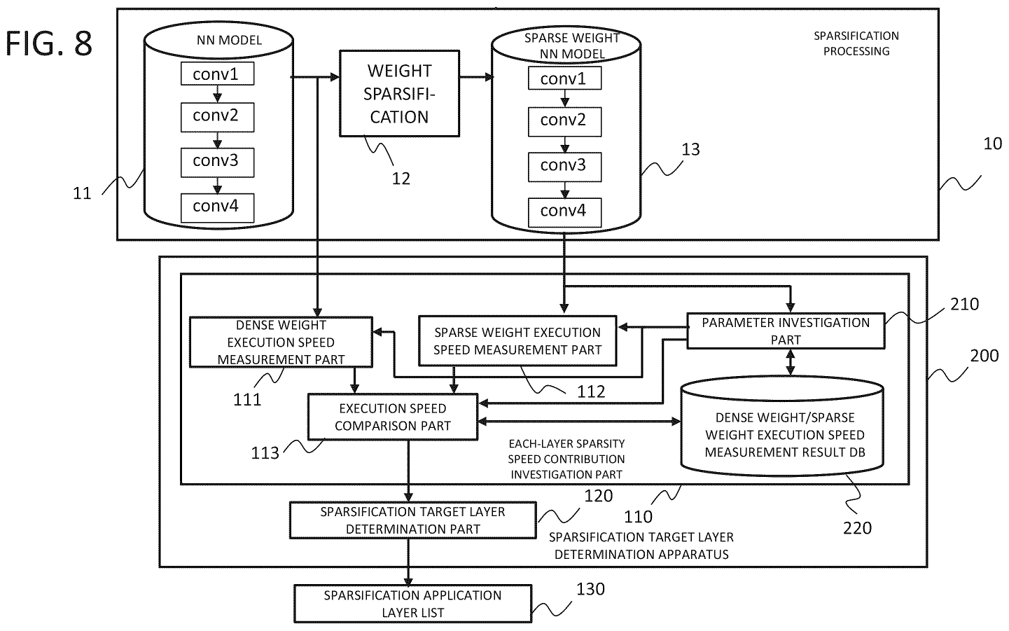

Next, a sparsification target layer determination apparatus 200 according to a second example embodiment of the present invention will be described with reference to drawings. FIG. 8 is a diagram illustrating an example of a configuration of a sparsification target layer determination apparatus 200 according to the second example embodiment of the present invention. In FIG. 8, components denoted by the same reference numerals as those in FIG. 2 indicate the same components, and description thereof will be omitted.

Note, the sparsification target layer determination apparatus 200 according to the second example embodiment of the present invention is configured and executed on an implementation target (real machine).

With reference to FIG. 8, a sparsification target layer determination apparatus 200 according to the second example embodiment of the present invention includes an each-layer sparsity speed contribution investigation part 110, a sparsification target layer determination part 120. The each-layer sparsity speed contribution investigation part 110 includes a dense weight execution speed measurement part 111, a sparse weight execution speed measurement part 112, an execution speed comparison part 113, and a parameter investigation part 210, a dense weight/sparse weight execution speed measurement result database (DB) 220. Note, the dense weight/sparse weight execution speed measurement result database (DB) 220 may be configured to be provided outside the sparsification target layer determination apparatus 200.

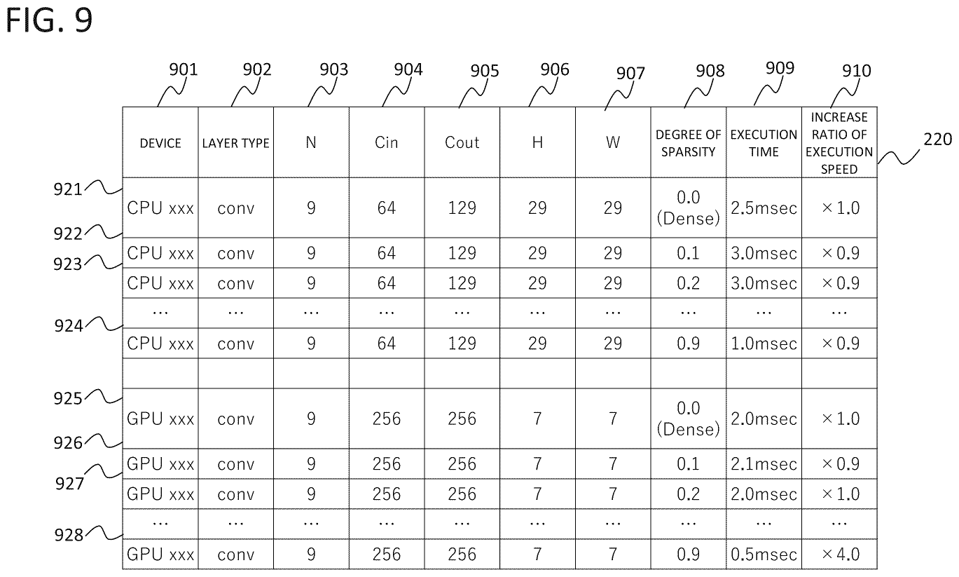

FIG. 9 is a diagram illustrating an example of a configuration of a dense weight/sparse weight execution speed measurement result database 220 according to the second example embodiment of the present invention. The dense weight/sparse weight execution speed measurement result database 220 is a database which stores a sparse case execution time 909 and an increase ratio of an execution speed 910, in relation to input parameters of a device 901, a layer type 902, a batch size (N) 903, a number of input channels (Cin) 904, a number of output channels (Cout) 905, a height (H) 906, a width (W) 907, a degree of sparsity 908. The device 901 is a parameter which corresponds to an implementation target (real machine).

With reference to FIG. 9, a row 921 shows a case where a degree of sparsity is 0.0, that is, a dense case without being sparsified. With reference to FIG. 8, this corresponds to a case of a neural network (NN) model 11. In contrast, a row 922 shows a case where a degree of sparsity is 0.1, a row 923 shows a case where a degree of sparsity is 0.2, and a row 924 shows a case where a degree of sparsity is 0.9, respectively. With reference to FIG. 8, these correspond to cases of sparse weight neural network (NN) models 13. Parameters other than a degree of sparsity are the same as those of the case of the row 921.

Furthermore, rows 925 to 928 store sparse case execution times 909 and increase ratios of an execution speeds 910 which correspond to different parameters from those of rows 921 to 924. The row 925 shows a case where a degree of sparsity is 0.0, that is, a dense case without being sparsified. With reference to FIG. 8, this corresponds to a case of a neural network (NN) model 11. In contrast, the row 926 shows a case where a degree of sparsity is 0.1, the row 927 shows a case where a degree of sparsity is 0.2, and the row 928 shows a case where a degree of sparsity is 0.9, respectively. With reference to FIG. 8, these correspond to cases of sparse weight neural network (NN) models 13. Parameters other than a degree of sparsity are the same as those of the case of the row 925.

Next, an example of an outline of an operation of the sparsification target layer determination apparatus 200 according to the second example embodiment of the present invention will be described with reference to drawings.

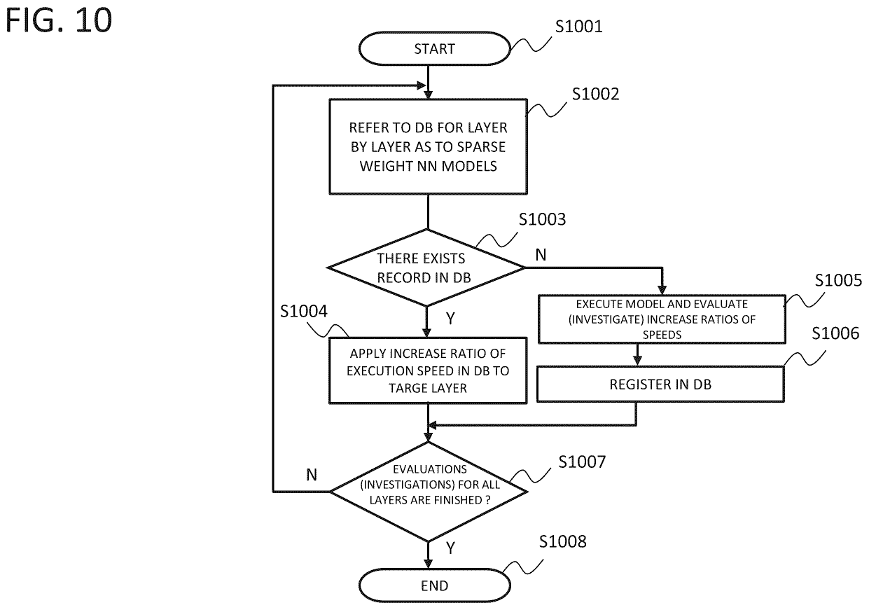

FIG. 10 is a flow diagram illustrating an example of an outline for an algorithm of an operation by a parameter investigation part 210 of an each-layer sparsity speed contribution investigation part 110 of a sparsification target layer determination apparatus 200 according to the second example embodiment of the present invention. The algorithm illustrated in FIG. 10 shows an example of an operation in a case where a neural network model 11 and one or more sparse weight neural network models 13 are respectively executable, layer by layer.

The algorithm as shown in FIG. 10 starts at a step S1001. At a step S1002, the parameter investigation part 210 refers to the dense weight/sparse weight execution speed measurement result database 220, layer by layer, as to the one or more sparse weight neural network (NN) models 13. Concretely, based on the parameters exemplified in FIG. 9, the parameter investigation part 210 searches the dense weight/sparse weight execution speed measurement result database 220 as to whether or not there exists a record corresponding to, for example, a conv1 layer of the one or more sparse weight neural network models 13.

At a step S1003, in a case where the parameter investigation part 210 determines that there exists a record corresponding to a conv1 layer in the database 220 (Y), the algorithm proceeds to a step S1004 and instructs the execution speed comparison part 113 to apply an increase ratio of an execution speed stored in the database 220 to the conv1 layer.

At the step S1003, in a case where the parameter investigation part 210 determines that there exists no record corresponding to a conv1 layer (N), the algorithm proceeds to a step S1005 and the parameter investigation part 210 instructs the dense weight execution speed measurement part 111, the sparse weight execution speed measurement part 112, and the execution speed comparison part 113 to execute conv1 layers of the neural network model 11 and sparse weight neural network models 13 to evaluate (investigate) increase ratios of speeds. Next, at a step S1006, the execution speed comparison part 113 registers increase ratios of speeds for conv1 layers in the database 220 with parameters.

Next, at a step S1007, the parameter investigation part 210 determines whether or not evaluations (investigations) for all layers have been finished. In a case where evaluations (investigations) for all layers have been finished, that is, evaluations (investigations) for a conv1 layer to a conv4 layer of the one or more sparse weight neural network models 13 as shown in FIG. 8 have been finished, the algorithm ends at a step S1008.

On the other hand, at the step S1007, evaluations (investigations) for all layers have not been finished yet, that is, evaluations for a conv1 layer to a conv4 layer of the one or more sparse weight neural network models 13 as shown in FIG. 8 have not been finished, the algorithm returns to the step S1002 and the parameter investigation part 210 repeats the above described steps for remaining layers (as to a conv2 layer to a conv4 layer).

According to the sparsification target layer determination apparatus 200 of the second example embodiment of the present invention, it is possible to speed-up calculations of increase ratios of execution speeds, layer by layer, using the dense weight/sparse weight execution speed measurement result database 220.

### MODIFIED EXAMPLE OF SECOND EXAMPLE EMBODIMENT

Next, an example of an outline of an operation of a sparsification target layer determination apparatus 200 according to a modified example of the second example embodiment of the present invention will be described with reference to drawings. Note, in the modified example of the second example embodiment, an outline of a configuration of a sparsification target layer determination apparatus 200 is the same as that of a sparsification target layer determination apparatus 200 according to the second example embodiment, and description thereof will be omitted.

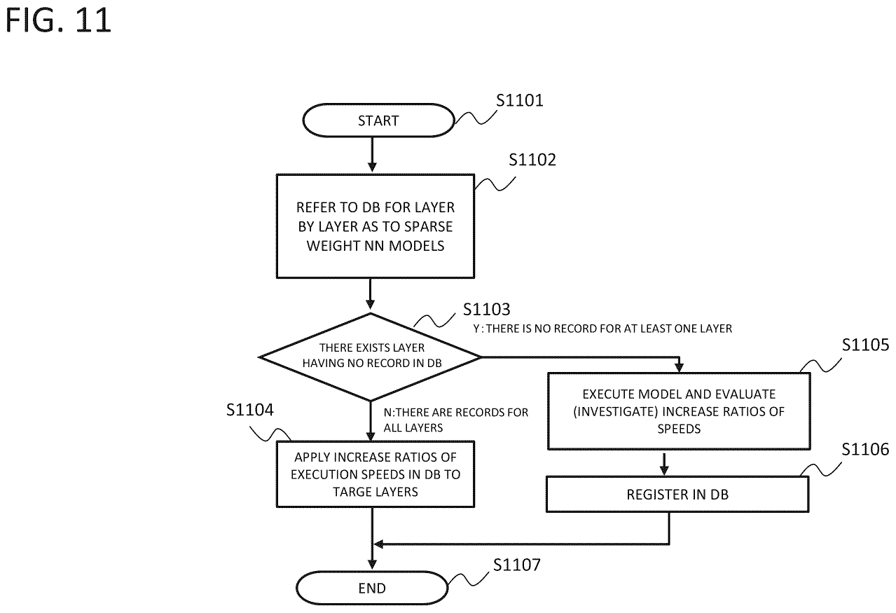

FIG. 11 is a flow diagram illustrating an example of an outline for an algorithm of an operation by a parameter investigation part 210 of each-layer sparsification speed contribution investigation part 110 of a sparsification target layer determination apparatus 200 according to the modified example of the second example embodiment of the present invention. An algorithm as shown in FIG. 11 shows an example of an operation in a case where both a neural network model 11 and one or more sparse weight neural network models 13 cannot be executed layer by layer, that is, the neural network model 11 and the one or more sparse weight neural network models 13 can only be executed as a whole.

The algorithm as shown in FIG. 11 starts at a step S1101. At a step S1102, a parameter investigation part 210 refers to a dense weight/sparse weight execution speed measurement result database (DB) 220, layer by layer, as to the one or more sparse weight neural network (NN) models 13. Concretely, based on the parameters exemplified in FIG. 9, the parameter investigation part 210 searches the dense weight/sparse weight execution speed measurement result database 220 as to whether or not there exists records corresponding to, for example, a conv1 layer to a conv4 layer of the one or more sparse weight neural network models 13.

At a step S1103, in a case where the parameter investigation part 210 determines that records of all layers, for example, a conv1 layer to conv4 layer exist (N), the algorithm proceeds to a step S1104 and instructs the execution speed comparison part 113 to apply increase ratios of execution speeds stored in the database 220, layer by layer. Then, the algorithm ends at a step S1107.

At the step S1103, in a case where the parameter investigation part 210 determines that there exist no record corresponding to at least one layer, for example, at least one layer among a conv1 layer to a conv4 layer (Y), the algorithm proceeds to a step S1105 and the parameter investigation part 210 instructs the dense weight execution speed measurement part 111, the sparse weight execution speed measurement part 112, and the execution speed comparison part 113 to execute all the layers of the neural network model 11 and one or more sparse weight neural network models 13, for example, a conv1 layer to a conv4 layer to evaluate (investigate) increase ratios of execution speeds.

Next, at a step S1106, the execution speed comparison part 113 registers increase ratios of execution speeds for all the layers which has been evaluated, for example a conv1 layer to a conv4 layer in the database 220 with parameters.

Next, the algorithm ends at a step S1107.

According to the modified example of the second example embodiment, even in a case where both a neural network model 11 and one or more sparse weight neural network models 13 cannot be executed layer by layer, that is, the neural network model 11 and the one or more sparse weight neural network models 13 can only be executed as a whole, it is possible to contribute to speed-up calculations of increase ratios of execution speeds, layer by layer.

The example embodiments of the present invention have been described as above, however, the present invention is not limited thereto. Further modifications, substitutions, or adjustments can be made without departing from the basic technical concept of the present invention. For example, the configurations of the system and the elements and the representation modes of the message or the like illustrated in the individual drawings are merely used as examples to facilitate the understanding of the present invention. Thus, the present invention is not limited to the configurations illustrated in the drawings. In addition, “A and/or B” in the following description signifies at least one of A or B.

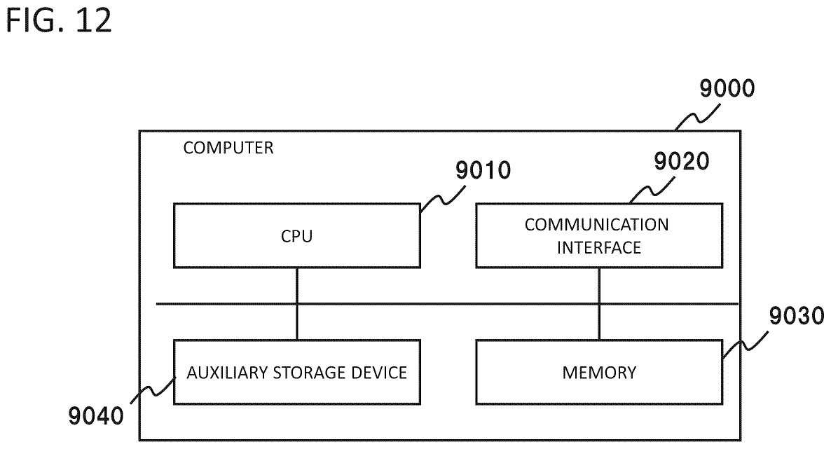

In addition, the procedures described in the above first example embodiment to the modified example of the second example embodiment can each be realized by a program causing a computer (9000 in FIG. 12) functioning as the sparsification target layer determination apparatus 100, 200to realize the functions as the sparsification target layer determination apparatus 100, 200. For example, this computer is configured to include a CPU (Central Processing Unit) 9010, a communication interface 9020, a memory 9030, and an auxiliary storage device 9040 in FIG. 12. That is, the CPU 9010 in FIG. 12 executes a sparsification target layer determination program and performs processing for updating various calculation parameters stored in the auxiliary storage device 9040 or the like.

The memory 9030 is a RAM (Random Access Memory) or a ROM (Read-Only Memory), and so on.

That is, the individual parts (processing means, functions) of each of the sparsification target layer determination apparatus in the first example embodiment to the modified example of the second example embodiment as described above can each be realized by a computer program that causes a processor of the computer to execute the corresponding processing described above by using corresponding hardware.

Finally, suitable modes of the present invention will be summarized.

### [Mode 1]

(See the sparsification target layer determination apparatus according to the above first aspect)

### [Mode 2]

The sparsification target layer determination apparatus according to mode 1, it is preferable that wherein the each-layer sparsity speed contribution investigation part compares, layer by layer, the execution time of the neural network model with respective execution times of the one or more sparse weight neural network models, and investigates, layer by layer, based on the comparison results, respective increase ratios of execution speeds of the one or more sparse weight neural network models; and

the sparsification target layer determination part determines that, for a layer of the neural network model, any one of the increase ratios of the execution speeds of which is more than or equal to a predetermined value, the sparsification is applied to the weights of the layer.

### [Mode 3]

The sparsification target layer determination apparatus according to mode 2, it is preferable that wherein the sparsification target layer determination part determines that, for a layer of the neural network model, all of the increase ratios of the execution speeds of which are less than a predetermined value, the sparsification is not applied to the weights of the layer.

### [Mode 4]

The sparsification target layer determination apparatus according to mode 2, it is preferable that wherein the sparsification target layer determination part determines whether or not to apply the sparsification to the weights of the layer, for respective of the layers of the neural network model, in such way that a sum of execution times of each of the layers of the neural network model is reduced to less than or equal to a predetermined value.

### [Mode 5]

The sparsification target layer determination apparatus according to any one of modes 2 to 4, it is preferable that wherein the each-layer sparsity speed contribution investigation part further comprises an execution speed measurement result database which stores increase ratios of execution speeds of the sparse weight neural network model,

in a case where an increase ratio of an execution speed of a layer which has the same parameter as a target layer of the sparse weight neural network model resides in the execution speed measurement result database;
acquires the increase ratio of the execution speed of the target layer from the execution speed measurement result database, and
in a case where an increase ratio of an execution speed of a layer which has the same parameter as a target layer of the sparse weight neural network model does not reside in the execution speed measurement result database;
compares an execution time of the target layer of the neural network model with an execution time of the target layer of the sparse weight neural network model,
investigates the increase ratio of the execution speed of the target layer, and
stores the parameter of the sparse weight neural network model and the increase ratio of the execution speed in the execution speed measurement result database.

### [Mode 6]

The sparsification target layer determination apparatus according to any one of modes 2 to 4, it is preferable that wherein the each-layer sparsity speed contribution investigation part further comprises an execution speed measurement result database which stores increase ratios of execution speeds of the sparse weight neural network model,

in a case where, for every layer of the sparse weight neural network model, an increase ratio of an execution speed of a layer which has the same parameter as a layer of the neural network model resides in the execution speed measurement result database;
acquires the increase ratios of the execution speeds for every layer of the sparse weight neural network model from the execution speed measurement result database, and
in a case where, for at least one layer of the sparse weight neural network model, an increase ratio of an execution speed of a layer which has the same parameter as a layer of the s neural network model does not reside in the execution speed measurement result database;
compares, layer by layer, for all the layers of the sparse weight neural network model, an execution time of the neural network model with an execution time of the sparse weight neural network model,
investigates, layer by layer, the increase ratio of the execution speed, and
stores the parameters of the sparse weight neural network model and the increase ratios of the execution speeds in the execution speed measurement result database.

### [Mode 7]

(See the sparsification target layer determination method according to the above second aspect)

### [Mode 8]

The sparsification target layer determination method according to mode 7, it is preferable that wherein the step of investigation comprises a step of comparing, layer by layer, the execution time of the neural network model with respective execution times of the one or more sparse weight neural network models, and investigating, layer by layer, based on the comparison results, respective increase ratios of execution speeds of the one or more sparse weight neural network models; and

the step of determining comprises a step of determining that, for a layer of the neural network model, any one of the increase ratios of the execution speeds of which is more than or equal to a predetermined value, the sparsification is applied to the weights of the layer.

### [Mode 9]

(See the program according to the above third aspect)

### [Mode 10]

The program according to mode 9, it is preferable that wherein

the processing of investigating comprises a processing of comparing, layer by layer, the execution time of the neural network model with respective execution times of the one or more sparse weight neural network models, and investigating, layer by layer, based on the comparison results, respective increase ratios of execution speeds of the one or more sparse weight neural network models; and
the processing of determining comprises a processing of determining that, for a layer of the neural network model, any one of the increase ratios of the execution speeds of which is more than or equal to a predetermined value, the sparsification is applied to the weights of the layer.

The above modes 7 and 9 can be expanded to the modes 3 to 6 in the same way as the mode 1 is expanded.

The disclosure of each of the above PTLs is incorporated herein by reference thereto. Modifications and adjustments of the example embodiments or examples are possible within the scope of the overall disclosure (including the claims) of the present invention and based on the basic technical concept of the present invention. Various combinations or selections of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be construed to have been concretely disclosed.

### REFERENCE SIGNS LIST

10 sparsification processing
11 neural network (NN) model
12 weight sparsification
13 sparse weight neural network (NN) model
100, 200 sparsification target layer determination apparatus
110 each-layer sparsity speed contribution investigation part
111 dense weight execution speed measurement part
112 sparse weight execution speed measurement part
113 execution speed comparison part
120 sparsification target layer determination part
130 sparsification applicable layer list
210 parameter investigation part
220 dense weight/sparse weight execution speed measurement result database (DB)
9000 computer
9010 CPU
9020 communication interface
9030 memory
9040 auxiliary storage device

What is claimed is:

1. A sparsification target layer determination apparatus, comprising:
at least a processor; and
a memory in circuit communication with the processor,
wherein the processor is configured to execute program instructions stored in the memory to perform:
receiving a neural network model which includes a plurality of layers each of which has weights and one or more sparse weight neural network models which have sparse weights obtained by applying sparsification to the weights, layer by layer, and investigates investigating, layer by layer, an execution time of the neural network model and one or more execution times of the one or more sparse weight neural network models; and
determining whether or not to apply sparsification to the weights of the neural network model, layer by layer, based on a result of the investigation.

2. The sparsification target layer determination apparatus according to claim 1, wherein
the investigating comprises comparing, layer by layer, the execution time of the neural network model with respective execution times of the one or more sparse weight neural network models, and investigating, layer by layer, based on the comparison results, respective increase ratios of execution speeds of the one or more sparse weight neural network models; and
the determining comprises determining that, for a layer of the neural network model, any one of the increase ratios of the execution speeds of which is more than or equal to a predetermined value, the sparsification is applied to the weights of the layer.

3. The sparsification target layer determination apparatus according to claim 2, wherein
the sparsification target layer determination part determining comprises determines determining that, for a layer of the neural network model, all of the increase ratios of the execution speeds of which are less than a predetermined value, the sparsification is not applied to the weights of the layer.

4. The sparsification target layer determination apparatus according to claim 2, wherein
the determining comprises determining whether or not to apply the sparsification to the weights of the layer, for respective of the layers of the neural network model, in such way that a sum of execution times of each of the layers of the neural network model is reduced to less than or equal to a predetermined value.

5. The sparsification target layer determination apparatus according to claim 2,
further comprising an execution speed measurement result database which stores increase ratios of execution speeds of the sparse weight neural network model, wherein
in a case where an increase ratio of an execution speed of a layer which has the same parameter as a target layer of the sparse weight neural network model resides in the execution speed measurement result database;
the investigating comprises acquiring the increase ratio of the execution speed of the target layer from the execution speed measurement result database, and
in a case where an increase ratio of an execution speed of a layer which has the same parameter as a target layer of the sparse weight neural network model does not reside in the execution speed measurement result database;
the investigating comprises comparing an execution time of the target layer of the neural network model with an execution time of the target layer of the sparse weight neural network model,
investigating the increase ratio of the execution speed of the target layer, and
storing the parameter of the sparse weight neural network model and the increase ratio of the execution speed in the execution speed measurement result database.

6. The sparsification target layer determination apparatus according to claim 2,
further comprising an execution speed measurement result database which stores increase ratios of execution speeds of the sparse weight neural network model, wherein
in a case where, for every layer of the sparse weight neural network model, an increase ratio of an execution speed of a layer which has the same parameter as a layer of the neural network model resides in the execution speed measurement result database;
the investigating comprises acquiring the increase ratios of the execution speeds for every layer of the sparse weight neural network model from the execution speed measurement result database, and
in a case where, for at least one layer of the sparse weight neural network model, an increase ratio of an execution speed of a layer which has the same parameter as a layer of the s neural network model does not reside in the execution speed measurement result database;
the investigating comprises comparing, layer by layer, for all the layers of the sparse weight neural network model, an execution time of the neural network model with an execution time of the sparse weight neural network model,
investigating, layer by layer, the increase ratio of the execution speed, and
storing the parameters of the sparse weight neural network model and the increase ratios of the execution speeds in the execution speed measurement result database.

7. A sparsification target layer determination method, comprising: performed by a computer including a processor and a memory,
receiving a neural network model which includes a plurality of layers each of which has weights and one or more sparse weight neural network models which have sparse weights obtained by applying sparsification to the weights, layer by layer, and investigating, layer by layer, an execution time of the neural network model and one or more execution times of the one or more sparse weight neural network models; and
determining whether or not to apply sparsification to the weights of the neural network model, layer by layer, based on a result of the investigation.

8. The sparsification target layer determination method according to claim 7, wherein
the investigating comprises comparing, layer by layer, the execution time of the neural network model with respective execution times of the one or more sparse weight neural network models, and investigating, layer by layer, based on the comparison results, respective increase ratios of execution speeds of the one or more sparse weight neural network models; and
the determining comprises determining that, for a layer of the neural network model, any one of the increase ratios of the execution speeds of which is more than or equal to a predetermined value, the sparsification is applied to the weights of the layer.

9. A computer-readable non-transitory recording medium recording a program, the program causing a computer to perform processings of:
receiving a neural network model which includes a plurality of layers each of which has weights and one or more sparse weight neural network models which have sparse weights obtained by applying sparsification to the weights layer by layer and investigating, layer by layer, an execution time of the neural network model and one or more execution times of the one or more sparse weight neural network models; and
determining whether or not to apply sparsification to the weights of the neural network model, layer by layer, based on a result of the investigation.

10. The medium according to claim 9, wherein
the processing of investigating comprises a processing of comparing, layer by layer, the execution time of the neural network model with respective execution times of the one or more sparse weight neural network models, and investigating, layer by layer, based on the comparison results, respective increase ratios of execution speeds of the one or more sparse weight neural network models; and
the processing of determining comprises a processing of determining that, for a layer of the neural network model, any one of the increase ratios of the execution speeds of which is more than or equal to a predetermined value, the sparsification is applied to the weights of the layer.

11. The sparsification target layer determination method according to claim 8, wherein
the determining comprises determining that, for a layer of the neural network model, all of the increase ratios of the execution speeds of which are less than a predetermined value, the sparsification is not applied to the weights of the layer.

12. The sparsification target layer determination method according to claim 8, wherein
the determining comprises determining whether or not to apply the sparsification to the weights of the layer, for respective of the layers of the neural network model, in such way that a sum of execution times of each of the layers of the neural network model is reduced to less than or equal to a predetermined value.

13. The sparsification target layer determination method according to claim 8, further comprising an execution speed measurement result database which stores increase ratios of execution speeds of the sparse weight neural network model, wherein
in a case where an increase ratio of an execution speed of a layer which has the same parameter as a target layer of the sparse weight neural network model resides in the execution speed measurement result database;
the investigating comprises acquiring the increase ratio of the execution speed of the target layer from the execution speed measurement result database, and in a case where an increase ratio of an execution speed of a layer which has the same parameter as a target layer of the sparse weight neural network model does not reside in the execution speed measurement result database;
the investigating comprises comparing an execution time of the target layer of the neural network model with an execution time of the target layer of the sparse weight neural network model,
investigating the increase ratio of the execution speed of the target layer, and
storing the parameter of the sparse weight neural network model and the increase ratio of the execution speed in the execution speed measurement result database.

14. The sparsification target layer determination method according to claim 8, further comprising an execution speed measurement result database which stores increase ratios of execution speeds of the sparse weight neural network model, wherein
in a case where, for every layer of the sparse weight neural network model, an increase ratio of an execution speed of a layer which has the same parameter as a layer of the neural network model resides in the execution speed measurement result database;
the investigating comprises acquiring the increase ratios of the execution speeds for every layer of the sparse weight neural network model from the execution speed measurement result database, and
in a case where, for at least one layer of the sparse weight neural network model, an increase ratio of an execution speed of a layer which has the same parameter as a layer of the s neural network model does not reside in the execution speed measurement result database;
the investigating comprises comparing, layer by layer, for all the layers of the sparse weight neural network model, an execution time of the neural network model with an execution time of the sparse weight neural network model,
investigating, layer by layer, the increase ratio of the execution speed, and
storing the parameters of the sparse weight neural network model and the increase ratios of the execution speeds in the execution speed measurement result database.

15. The medium according to claim 10, wherein
the processing of determining comprises determining that, for a layer of the neural network model, all of the increase ratios of the execution speeds of which are less than a predetermined value, the sparsification is not applied to the weights of the layer.

16. The medium according to claim 10, wherein
the processing of determining comprises determining whether or not to apply the sparsification to the weights of the layer, for respective of the layers of the neural network model, in such way that a sum of execution times of each of the layers of the neural network model is reduced to less than or equal to a predetermined value.

17. The medium according to claim 10, wherein
in a case where an increase ratio of an execution speed of a layer which has the same parameter as a target layer of the sparse weight neural network model resides in an execution speed measurement result database;
the processing of investigating comprises acquiring the increase ratio of the execution speed of the target layer from the execution speed measurement result database, and
in a case where an increase ratio of an execution speed of a layer which has the same parameter as a target layer of the sparse weight neural network model does not reside in the execution speed measurement result database;
the processing of investigating comprises comparing an execution time of the target layer of the neural network model with an execution time of the target layer of the sparse weight neural network model,
investigating the increase ratio of the execution speed of the target layer, and
storing the parameter of the sparse weight neural network model and the increase ratio of the execution speed in the execution speed measurement result database.

18. The medium according to claim 10, wherein
in a case where, for every layer of the sparse weight neural network model, an increase ratio of an execution speed of a layer which has the same parameter as a layer of the neural network model resides in an execution speed measurement result database;
the processing of investigating comprises acquiring the increase ratios of the execution speeds for every layer of the sparse weight neural network model from the execution speed measurement result database, and
in a case where, for at least one layer of the sparse weight neural network model, an increase ratio of an execution speed of a layer which has the same parameter as a layer of the s neural network model does not reside in the execution speed measurement result database;
the processing of investigating comprises comparing, layer by layer, for all the layers of the sparse weight neural network model, an execution time of the neural network model with an execution time of the sparse weight neural network model,
investigating, layer by layer, the increase ratio of the execution speed, and
storing the parameters of the sparse weight neural network model and the increase ratios of the execution speeds in the execution speed measurement result database.
